(19) United States
(12) Patent Application Publication
(10) Pub. No.: US 2023/0391359 A1
(43) Pub. Date: Dec. 7, 2023

(54) AUTOMATED DRIVING ASSISTANCE APPARATUS AND METHOD FOR ASSISTING AUTOMATED DRIVING

(71) Applicant: Mitsubishi Electric Corporation, Tokyo (JP)

(72) Inventors: Norihiro NISHIUMA, Tokyo (JP); Yuji HAMADA, Tokyo (JP); Kenta SAKURAI, Tokyo (JP)

(73) Assignee: Mitsubishi Electric Corporation, Tokyo (JP)

(21) Appl. No.: 18/033,559

(22) PCT Filed: Jan. 13, 2021
(86) PCT No.: PCT/JP2021/000824

§ 371 Date: Apr. 25, 2023

(51) Int. Cl. B60W 60/00; B60W 40/10; B60W 40/02

(52) U.S. Cl. CPC B60W 60/001; B60W 40/10; B60W 40/02; B60W 2556/10

(57) ABSTRACT

The object is to provide a technology for enabling appropriate learning of automated driving control. An automated driving assistance apparatus includes: a traveling history obtaining unit obtaining a traveling history including a manual driving operation on a vehicle, a vehicle position that is a position of the vehicle, and a time of the manual driving operation and a time at the vehicle position; a traveling trajectory estimator estimating a traveling trajectory of the vehicle; and a surrounding environment estimator estimating a surrounding environment of the vehicle, the surrounding environment being used as learning data of a planned algorithm for planning control of the automated driving of the vehicle.

### TECHNICAL FIELD

The present disclosure relates to an automated driving assistance apparatus and a method for assisting automated driving.

### BACKGROUND ART

An automated driving assistance apparatus described in Patent Document 1 includes: a record processing unit that records an operation history including manual driving operations conducted by a driver and locations at which the driver has conducted the manual driving operations; and a driving controller that controls automated driving of a vehicle at the locations indicated by the operation history, based on the driving operations indicated by the operation history. Such an automated driving assistance apparatus can learn the automated driving control, based on the driving operations conducted by the driver.

### PRIOR ART DOCUMENT

### Patent Document

Patent Document 1: Japanese Patent Application Laid-Open No. 2019-51933

### Problem to be Solved by the Invention

Since the automated driving assistance apparatus controls the automated driving based on the locations at which the driving operations have been intermittently recorded, the apparatus cannot learn the automated driving control in consideration of a continuous change in position of the vehicle and a surrounding environment that changes moment by moment. This causes a problem that the apparatus cannot appropriately learn the automated driving control.

The present disclosure has been conceived in view of the problem, and has an object of providing a technology for enabling appropriate learning of the automated driving control.

### Means to Solve the Problem

An automated driving assistance apparatus according to the present disclosure is an automated driving assistance apparatus assisting automated driving of a vehicle, and includes: a traveling history obtaining unit to obtain a traveling history including a manual driving operation on the vehicle, a vehicle position that is a position of the vehicle, and a time of the manual driving operation and a time at the vehicle position; a traveling trajectory estimator to estimate a traveling trajectory of the vehicle by checking the traveling history against map information; and a surrounding environment estimator to estimate a surrounding environment of the vehicle based on the manual driving operation on the traveling trajectory, the surrounding environment being used as learning data of a planned algorithm for planning control of the automated driving of the vehicle.

### Effects of the Invention

The present disclosure allows estimation of a surrounding environment of a vehicle based on a manual driving operation on a traveling trajectory. The surrounding environment is used as learning data of a planned algorithm for planning control of automated driving of the vehicle. This configuration enables appropriate learning of the automated driving control.

The object, features, aspects, and advantages of the present disclosure will become more apparent from the following detailed description and the accompanying drawings.

### BRIEF DESCRIPTION OF DRAWINGS

FIG. 1 is a block diagram illustrating a configuration of an automated driving system according to Embodiment 1.

FIG. 2 illustrates estimation of a traveling trajectory estimator according to Embodiment 1.

FIG. 3 illustrates estimation of the traveling trajectory estimator according to Embodiment 1.

FIG. 4 illustrates estimation of the traveling trajectory estimator according to Embodiment 1.

FIG. 5 illustrates estimation of a surrounding environment estimator according to Embodiment 1.

FIG. 6 is a block diagram illustrating a hardware configuration of an automated driving assistance apparatus according to other modifications.

FIG. 7 is a block diagram illustrating a hardware configuration of the automated driving assistance apparatus according to the other modifications.

### DESCRIPTION OF EMBODIMENTS

### Embodiment 1

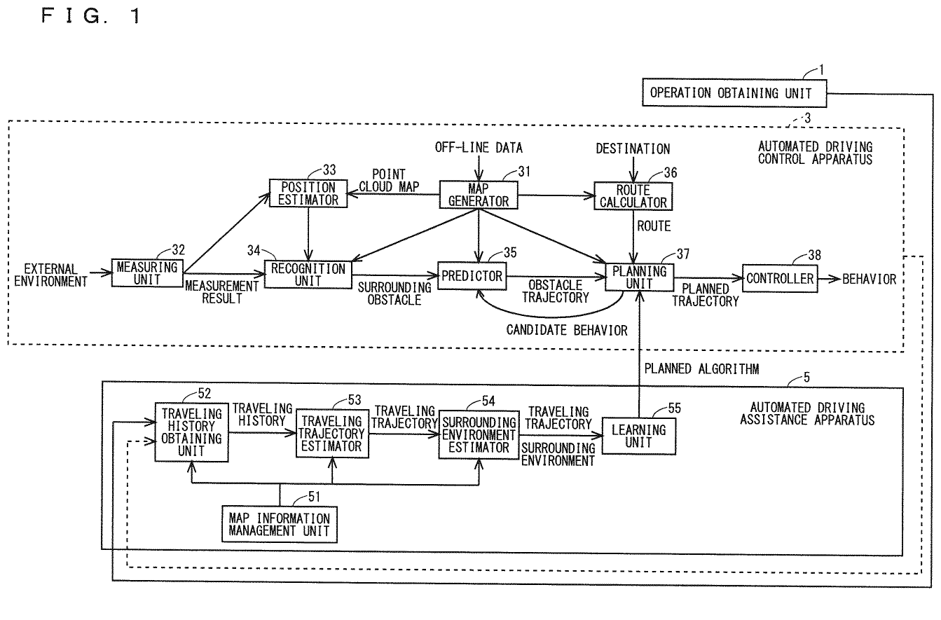

FIG. 1 is a block diagram illustrating a configuration of an automated driving system according to Embodiment 1. The automated driving system in FIG. 1 includes an operation obtaining unit 1, an automated driving control apparatus 3, and an automated driving assistance apparatus 5. The automated driving system is a system ranked higher than a drive system, a steering system, and a braking system that are basic control systems, and is an integrated system that replaces recognition, judgment, planning, and operations that humans conventionally perform by, for example, controlling automated driving of an automated driving vehicle. Hereinafter, an automated driving vehicle that is a vehicle to be controlled in an automated driving system and that can be manually driven by a manual driving operation may be referred to as a “subject vehicle”.

[Operation Obtaining Unit]

The operation obtaining unit 1 obtains a manual driving operation on a subject vehicle from the driver. Examples of the operation obtaining unit 1 include an accelerator pedal that obtains an accelerator operation of the subject vehicle as a manual driving operation, a brake pedal that obtains a brake operation of the subject vehicle as a manual driving operation, and a steering wheel that obtains a steering wheel operation of the subject vehicle as a manual driving operation.

[Automated Driving Control Apparatus]

The automated driving control apparatus 3 controls the automated driving of the subject vehicle in cooperation with the automated driving assistance apparatus 5. The automated driving control apparatus 3 in FIG. 1 includes a map generator 31, a measuring unit 32, a position estimator 33, a recognition unit 34, a predictor 35, a route calculator 36, a planning unit 37, and a controller 38.

The map generator 31 generates map information to be used in the automated driving system, using off-line data encoded in advance. The map information is, for example, information on a point cloud map that can represent a highly accurate three-dimensional road space on a computer. The measuring unit 32 measures an external environment of the subject vehicle using, for example, radar, LiDAR, or a camera.

The position estimator 33 estimates a position of the subject vehicle, based on the map information generated by the map generator 31 and a measurement result of the measuring unit 32. The position estimator 33 outputs the estimated position of the subject vehicle to the recognition unit 34 and the route calculator 36, which is only partly illustrated in FIG. 1. When the map information generated by the map generator 31 is the information on the point cloud map, the constituent elements of the automated driving control apparatus 3 can read, from the information on the point cloud map, road surface information such as dividing lines and road appendage information such as lights and traffic signs. Here, the position estimator 33 that is a constituent element of the automated driving control apparatus 3 can estimate an accurate position of the subject vehicle by checking the point cloud map against the measurement result of the measuring unit 32.

The recognition unit 34 extracts an obstacle around the subject vehicle from the external environment measured by the measuring unit 32, based on the position of the subject vehicle estimated by the position estimator 33. The predictor 35 predicts a movement of the obstacle extracted by the recognition unit 34, as an obstacle trajectory. The route calculator 36 calculates a route, based on the map information generated by the map generator 31, the position of the subject vehicle estimated by the position estimator 33, and a destination.

The planning unit 37 generates control information for controlling the automated driving of the subject vehicle, that is, a planned trajectory of the subject vehicle, based on the obstacle trajectory predicted by the predictor 35, the route calculated by the route calculator 36, and a planned algorithm from the automated driving assistance apparatus 5. The planned algorithm is an algorithm for planning control of the automated driving of the subject vehicle. The controller 38 determines a behavior of a driving unit such as an actuator of the subject vehicle, based on the control information (i.e., a planned trajectory) generated by the planning unit 37.

[Automated Driving Assistance Apparatus]

The automated driving assistance apparatus 5 assists the automated driving of the subject vehicle. The automated driving assistance apparatus 5 in FIG. 1 includes a map information management unit 51, a traveling history obtaining unit 52, a traveling trajectory estimator 53, a surrounding environment estimator 54, and a learning unit 55.

[Map Information Management Unit]

The map information management unit 51 stores and manages the map information to be used in the automated driving assistance apparatus 5. Examples of the map information include road information such as shapes of roads, the number of lanes, and restrictions.

[Traveling History Obtaining Unit]

The traveling history obtaining unit 52 obtains a traveling history including a manual driving operation on the subject vehicle, a subject vehicle position that is a position of the subject vehicle, and a time of the manual driving operation and a time at the subject vehicle position. Although the traveling history obtaining unit 52 according to Embodiment 1 obtains the manual driving operation from the operation obtaining unit 1 and obtains the subject vehicle position from the automated driving control apparatus 3, the method is not limited to this. The traveling history obtaining unit 52 may obtain a subject vehicle position, for example, calculated by a Global Positioning System (GPS) receiver that is not illustrated.

The traveling history obtaining unit 52 may collect a traveling history periodically at regular time intervals, for example, once every 100 ms, or collect a traveling history periodically at regular distance intervals, for example, once every 1 m. The traveling history obtaining unit 52 may collect a traveling history non-periodically when a driving operation is performed a number of times higher than or equal to a certain threshold.

As described above, the traveling history obtaining unit 52 obtains the manual driving operation to be performed on an interface that is an interaction node between a driver and the subject vehicle for causing the subject vehicle to travel, and a subject vehicle position that is a result of the interaction. Since the traveling history obtaining unit 52 does not identify the driver, privacy-preserving measurements such as deleting, encrypting, or anonymizing information for identifying the driver are unnecessary.

[Traveling Trajectory Estimator]

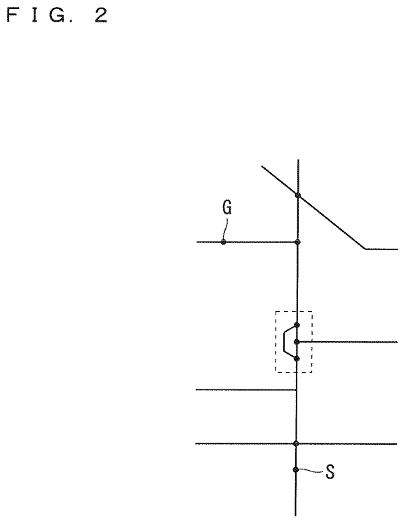

The traveling trajectory estimator 53 estimates a traveling trajectory of the subject vehicle by checking the traveling history of the traveling history obtaining unit 52 against the map information of the map information management unit 51. The traveling trajectory estimator 53 estimates the traveling trajectory of the subject vehicle by checking, for example, the subject vehicle position included in the traveling history, a change in traveling direction (also referred to as an orientation change) of the subject vehicle indicated by the steering wheel operation as the manual driving operation included in the traveling history, and the road information included in the map information. The traveling trajectory is represented by times and coordinates in the map information. Specific examples of estimation performed by the traveling trajectory estimator 53 will be described below.
(1) As illustrated in FIG. 2, the traveling trajectory estimator 53 determines, from the traveling history obtained by the traveling history obtaining unit 52 after traveling of the subject vehicle, a start point S that is a departure location of the traveling and an end point G that is an arrival location of the traveling. Specifically, the traveling trajectory estimator 53 determines, based on the subject vehicle position and the times in the traveling history and the map information, the start point S that is a position at which the subject vehicle enters a road and the end point G that is a position at which the subject vehicle exits from a road.

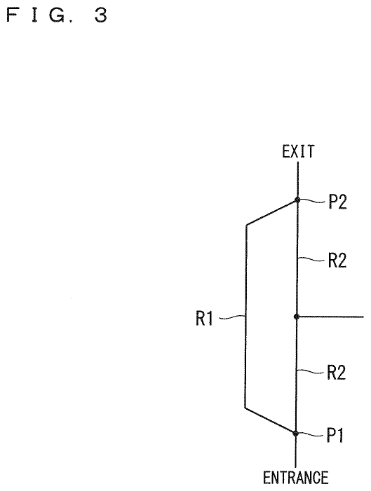

The traveling trajectory estimator 53 may determine, as the start point S and the end point G, locations at which the traveling trajectory estimator 53 can determine that sufficient position accuracy can be secured in consideration of, for example, a density of a road network represented by roads and lanes in the map information and the GPS reception accuracy to improve the position accuracy. The traveling trajectory estimator 53 may determine the start point S and the end point G using a traveling trajectory excluding data of a predetermined period after the subject vehicle starts to drive or before the subject vehicle finishes driving so that, for example, a home or an office is not identified for preserving privacy. Furthermore, the traveling trajectory estimator 53 may determine the start point S and the end point G in consideration of supplementary information from, for example, a camera to improve the position accuracy.
(2) The traveling trajectory estimator 53 determines a traveling direction and a traveling lane of the subject vehicle, using data of traveling trajectories from the time of the start point S in order of the times of the traveling trajectories. Specifically, the traveling trajectory estimator 53 determines a traveling direction and a traveling lane of the subject vehicle on a road network, based on a subject vehicle position at a time of interest in which the traveling trajectory estimator 53 is interested, a subject vehicle position at a time next to the time of interest, and a steering wheel operation caused by a right or left turn or a lane change of the subject vehicle. As illustrated in, for example, FIG. 3 that is an enlarged view of a broken-line portion in FIG. 2, when the manual driving operation included in the traveling history indicates a steering wheel operation for turning the subject vehicle left in at least one of a location P1 or a location P2, the traveling trajectory estimator 53 determines an elevated highway R1 to be a traveling lane of the subject vehicle. When the manual driving operation included in the traveling history does not indicate the steering wheel operation for turning the subject vehicle left in the location P1 or the location P2, the traveling trajectory estimator 53 determines a bypass R2 to be a traveling lane of the subject vehicle.

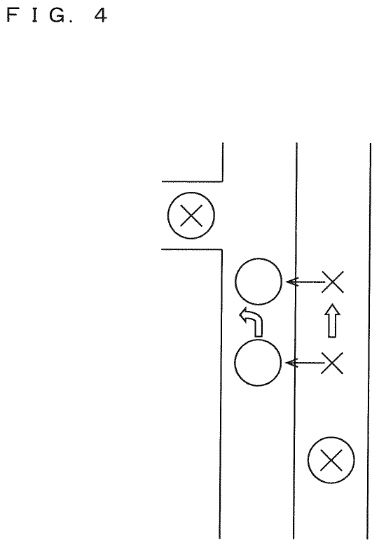

Next, the traveling trajectory estimator 53 corrects the subject vehicle position at the time of interest, based on the determined traveling lane of the subject vehicle and the map information. Assume an example case where the map information indicates that a vehicle traveling along a left lane can only turn left into a left-hand traffic road and the subject vehicle position in the traveling history indicates that the subject vehicle is traveling along a right lane that is a through lane on roads immediately before turning left as indicated by x marks in FIG. 4. Here, the traveling trajectory estimator 53 corrects the subject vehicle position so that the subject vehicle immediately before turning left runs along a left lane indicated by circles in FIG. 4 from the right lane indicated by the x marks in FIG. 4, based on the traveling lane of the subject vehicle and the map information. When the subject vehicle enters an adjacent road in turning right or left and there is a discrepancy in the traveling lane, the traveling trajectory estimator 53 may redetermine a traveling lane.

The traveling trajectory estimator 53 may correct the subject vehicle position in various methods. For example, the traveling trajectory estimator 53 may draw a perpendicular from the subject vehicle position to a center line of a road or a lane, and correct coordinates of the intersection point to obtain a corrected subject vehicle position. For example, the traveling trajectory estimator 53 may correct coordinates that are the closest to the subject vehicle position in a coordinate group that has been assigned to a road or a lane and that includes grid intersections and center points of three-dimensional cells obtained by dividing a three-dimensional space that can represent, for example, an elevated highway to obtain a corrected subject vehicle position.
(3) The traveling trajectory estimator 53 repeats the estimation in (2) until the end point, and determines whether the final subject vehicle position is the subject vehicle position at the end point which has been determined in (1). Then, when the final subject vehicle position is the subject vehicle position at the end point which has been determined in (1), the traveling trajectory estimator 53 estimates a traveling trajectory of the subject vehicle, based on the subject vehicle position obtained in (2).

Since the traveling trajectory estimator 53 corrects the subject vehicle position by checking the subject vehicle position against the map information, the accuracy required for a positioning unit can be relaxed. Since the traveling trajectory estimator 53 estimates a continuous traveling trajectory, the constituent elements that perform operations after the traveling trajectory estimator 53 can process continuous information. The traveling trajectory estimator 53 may be configured to check the subject vehicle position against the map information holding a road network in traveling, aside from the map information used in an on-vehicle terminal such as navigation. This can relax restrictions on the frequency of updating the map information of the on-vehicle terminal.

Although the configuration for the traveling trajectory estimator 53 to estimate traveling trajectories from a time of the start point in a time order is described above, the configuration is not limited to this. The traveling trajectory estimator 53 may compare, through pattern matching, coordinate information on the subject vehicle position in the traveling history with coordinates in road networks in the map information to narrow down the road networks to be used for traveling trajectories in advance. This can reduce errors in estimation between general highways and expressways running along the general highways as elevated highways, and reduce a computational complexity required for the estimation by narrowing down the road networks to be used for traveling trajectories in advance.

The traveling trajectory estimator 53 may be configured to correct a traveling trajectory through a sequential simulation in which a physical vehicle model is sequentially applied to traveling of the subject vehicle from the start point to the end point, after estimating the traveling trajectory. The physical vehicle model is a model that represents a dynamic behavior of the subject vehicle in consideration of, for example, a mass of the subject vehicle [kg], gravitational acceleration [m/s²], and a road gradient. Input of the physical vehicle model is, for example, a driving operation of the subject vehicle. Output of the physical vehicle model is, for example, a speed, an orientation, or a position of the subject vehicle. Since such a configuration enables the surrounding environment estimator 54 to estimate a surrounding environment using the traveling trajectory with estimation accuracy increased through the sequential simulation using the physical vehicle model, which will be described later, the accuracy of estimating the surrounding environment can be increased.

Although the configuration for the traveling trajectory estimator 53 to estimate a traveling trajectory of the subject vehicle using the subject vehicle position is described above, the configuration is not limited to this. The traveling trajectory estimator 53 may estimate a traveling trajectory of the subject vehicle, for example, using a physical quantity substantially equivalent to a subject vehicle position, such as a subject vehicle speed. Specifically, the traveling trajectory estimator 53 may divide a physical quantity at a location at which turning right or left of the subject vehicle is assumed, such as a location at which an amount of the steering wheel operation higher than or equal to a certain threshold is stored, and calculate a traveling distance between the dividing locations by integrating a traveling speed between the dividing locations. Then, the traveling trajectory estimator 53 may find a road network that matches the traveling distance between the locations and a change in the traveling direction at the locations, and estimate a traveling trajectory of the subject vehicle from the road network. The traveling trajectory estimator 53 with such a configuration can estimate a traveling trajectory of the subject vehicle, for example, without using satellite positioning that is susceptible to an influence in tunnels or in urban areas with many high-rise buildings.

Furthermore, a traveling trajectory between locations need not be a simple straight line. The traveling trajectory estimator 53 may estimate a road network by allowing a change in the traveling direction of the subject vehicle which is caused by linear characteristics of the subject vehicle and a cross slope such as a bank on a road, that is, a change in shape appearing as a curvature of a traveling trajectory of the subject vehicle. The linear characteristics of the subject vehicle herein include characteristics ascribable to steering wheel operations for following a road shape and changing a lane and to a steering system. The traveling trajectory estimator 53 with such a configuration can increase flexibility to regional characteristics, and increase the accuracy of estimating a traveling trajectory of the subject vehicle. Even when the traveling trajectory estimator 53 is configured to estimate a traveling trajectory after estimating a road network, the traveling trajectory estimator 53 may estimate traveling trajectories from a time of the start point in a time order, or perform a sequential simulation on a physical vehicle model as described above.

Furthermore, the traveling trajectory estimator 53 may find an amount of the steering wheel operation and a traveling distance of the subject vehicle from the traveling history, and determine a section in which the traveling trajectory estimator 53 performs the check to estimate a traveling trajectory of the subject vehicle, based on the amount of the steering wheel operation and the traveling distance. For example, the traveling trajectory estimator 53 may shorten the section in which the traveling trajectory estimator 53 performs the check as the number of operations for turning right and left increases. Alternatively, the traveling trajectory estimator 53 may lengthen the section in which the traveling trajectory estimator 53 performs the check as the traveling distance is increased. Such a configuration can increase the checking frequency when the traveling of the subject vehicle has a feature value and complexity higher than or equal to a certain threshold. Thus, the traveling trajectory estimator 53 can uniquely determine the subject vehicle position in a road network, and consequently increase the accuracy of estimating the traveling trajectory of the subject vehicle.

[Surrounding Environment Estimator]

The surrounding environment estimator 54 estimates a surrounding environment of the subject vehicle, based on the traveling trajectory estimated by the traveling trajectory estimator 53 and the manual driving operation included in the traveling history. For example, the surrounding environment estimator 54 estimates a surrounding environment, based on manual driving operations on a traveling trajectory, such as an accelerator operation, a brake operation, and a steering wheel operation. The learning unit 55 to be described later learns a planned algorithm, using the surrounding environment as learning data. Examples of the surrounding environment include a position and a motion trajectory of an obstacle around the subject vehicle, and a change in signal of an intersection traffic light. Examples of the obstacle include other vehicles, motorbikes, bicycles, and pedestrians around the subject vehicle. An area “around the subject vehicle” is, for example, an area that affects traveling of the subject vehicle. Examples of the motion trajectory of the obstacle include trajectories of deceleration, acceleration, popping out, and cutting in of the obstacle. Specific examples of estimation performed by the surrounding environment estimator 54 will be described below.
(1) The surrounding environment estimator 54 identifies at least one of a time point or a location at which a brake operation and a steering wheel operation without involving a lane change have been performed on a traveling trajectory, as at least one of a specific time point or a specific location based on the traveling trajectory and the manual driving operation. Although operations when the surrounding environment estimator 54 uses the specific time point will be described hereinafter, the operations are identical to those when the surrounding environment estimator 54 uses both of the specific time point and the specific location and to those when the surrounding environment estimator 54 uses the specific location.
(2) The surrounding environment estimator 54 estimates a surrounding environment, based on a manual driving operation at the specific time point, such as a brake operation (e.g., a depression amount and a depressing time of a brake), a steering wheel operation, and an accelerator operation after the brake operation. The surrounding environment estimator 54 may estimate a surrounding environment in consideration of not only the manual driving operation but also a traveling speed, a road structure, a road shape, and features around a road at the specific time point.

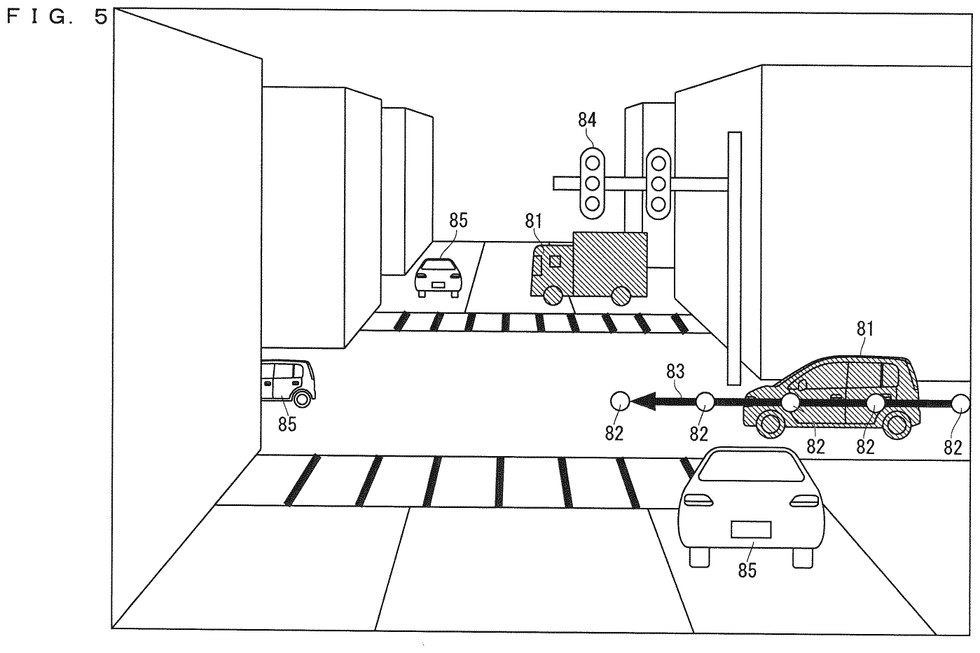

For example, the surrounding environment estimator 54 estimates a traveling trajectory of the subject vehicle in the absence of the manual driving operation at the specific time point, as a traveling trajectory without any operation. Then, the surrounding environment estimator 54 estimates positions and motion trajectories of an obstacle that comes in contact with the subject vehicle and an obstacle that probably comes in contact with the subject vehicle as a surrounding environment, based on a difference between the traveling trajectory estimated by the traveling trajectory estimator 53 and the traveling trajectory without any operation. Furthermore, the surrounding environment estimator 54 estimates a change in signal of an intersection traffic light as a surrounding environment, based on a change in subject vehicle position that is indicated by a traveling trajectory and positions of the obstacles for each time. FIG. 5 illustrates a motion trajectory of an obstacle 81 that probably comes in contact with the subject vehicle, using an arrow 83 that passes through a position 82 of the obstacle 81 for each time, and also an intersection traffic light 84 whose signal changes. The surrounding environment estimated by the surrounding environment estimator 54 may be information that can be displayed as illustrated in FIG. 5, or need not be such information.
(3) The surrounding environment estimator 54 outputs the estimated surrounding environment to the learning unit 55 as learning data, with the surrounding environment being changed into a data format of the learning unit 55.

The traveling trajectory of the subject vehicle that has been estimated by the traveling trajectory estimator 53 and the surrounding environment estimated by the surrounding environment estimator 54 may be represented by an occupied state of a space for each time in a period to be predicted or planned from the past to the future.

When estimating a motion trajectory of an obstacle, the surrounding environment estimator 54 may extract a similar motion trajectory from motion trajectories collected and estimated in the past, and adjust, for example, a motion time and a motion speed that represent the motion trajectory so that the motion trajectory conforms to a positional relationship between the subject vehicle and the obstacle at the specific time point.

In addition to the motion trajectory of the obstacle, the surrounding environment estimator 54 may estimate, as a non-affecting object, for example, an obstacle 85 that is not hatched in FIG. 5 and is an estimated obstacle whose position and speed do not affect a driving operation of the subject vehicle. For example, the surrounding environment estimator 54 may determine whether the subject vehicle and a surrounding vehicle have a positional relationship of approaching to each other, based on positions and orientations of the subject vehicle and the surrounding vehicle, e.g., when the vehicles are approaching to an intersection or when the vehicles are traveling along the same lane. Then, when determining that the subject vehicle and the surrounding vehicle have the positional relationship of approaching to each other, the surrounding environment estimator 54 may determine the surrounding vehicle to be an affecting object. When determining that the subject vehicle and the surrounding vehicle have a positional relationship of moving away from each other, the surrounding environment estimator 54 may determine the surrounding vehicle to be a non-affecting object. The surrounding environment estimator 54 may find a time until the subject vehicle comes in contact with a surrounding object, based on a relative speed and a relative distance of the subject vehicle to the surrounding vehicle, and determine whether the surrounding object is a non-affecting object based on whether the time is longer than or equal to a threshold. Accordingly, the learning unit 55 to be described later can simulate a non-affecting object determined not to affect driving of the subject vehicle after the driver recognizes the object, and learn characteristics of the human driver by extracting only necessary information from a complicated surrounding environment.

Furthermore, when the traveling trajectory estimator 53 estimates a plurality of traveling trajectories, the surrounding environment estimator 54 may estimate a surrounding environment preferentially using a traveling trajectory whose amount and time of a manual driving operation are less among the plurality of traveling trajectories. This configuration can apply, to automated driving, driving of a human driver whose operations leading to sudden acceleration, sudden braking, and wasteful periodic behaviors are less and whose driving skill is high to extend a driving time of a robot driver, and can reduce the frequency of manual intervention.

[Learning Unit]

The learning unit 55 learns a planned algorithm, based on the learning data corresponding to the surrounding environment estimated by the surrounding environment estimator 54. The planned algorithm is an algorithm for planning a part or the entirety of control of automated driving of the subject vehicle. Input of the planned algorithm is, for example, map information, a route of the subject vehicle, and a motion trajectory of an obstacle. Output of the planned algorithm is, for example, control information for controlling automated driving in the subject vehicle. The learning unit 55 learns a planned algorithm using, for example, learning through an Artificial Intelligence (AI) technique such as machine learning.

The learning unit 55 outputs the planned algorithm that is a learning result to the planning unit 37. As described above, the planning unit 37 generates control information (i.e., a planned trajectory) for controlling automated driving in the subject vehicle, based on the obstacle trajectory predicted by the predictor 35, the route calculated by the route calculator 36, and the planned algorithm from the automated driving assistance apparatus 5.

The planning unit 37 may generate the control information for controlling automated driving in the subject vehicle, based on the traveling trajectory estimated by the traveling trajectory estimator 53 and the planned algorithm of the learning unit 55. In other words, the planning unit 37 may generate the control information using the traveling trajectory and the planned algorithm. Then, the planning unit 37 may check validity of a traveling trajectory or correct the traveling trajectory, based on the control information generated using the traveling trajectory and the planned algorithm. Since such a configuration can early check or correct the traveling trajectory before completion of the processes in the surrounding environment estimator 54 and the learning unit 55, the reliability of the output of the planned algorithm can be enhanced.

### Summary of Embodiment 1

The automated driving assistance apparatus 5 according to Embodiment 1 estimates a traveling trajectory based on a traveling history including a manual driving operation and map information, estimates a surrounding environment from the traveling trajectory, and uses the estimated surrounding environment as learning data for a planned algorithm. Such a configuration enables learning of automated driving control, in consideration of a continuous traveling trajectory and a continuous surrounding environment obtained from the traveling trajectory. Thus, improvement on safety and robustness of the automated driving control can be expected.

Furthermore, there is no need to generate an enormous amount of information for estimating a surrounding environment, for example, measurement information from radar, LiDAR, or a camera and simulation data using a simulator, all of which are necessary for learning a planned algorithm. This can increase the efficiency of a process of generating learning data for a planned algorithm.

Since behaviors of, for example, machine learning are conventionally inductively determined, this creates a problem of failing to conduct the quality assurance of software, and further creates a serious problem in implementing and popularizing automated driving vehicles together with its development of legal systems. In contrast, Embodiment 1 allows learning of a planned algorithm, based on not only traveling in a virtual space using a simulator but also actual manual driving operations. This can contribute to a solution to the technical problem on the quality assurance of the planned algorithm.

Until the widespread use of automated driving vehicles contributes to reduced traffic congestion, it is said that manual driving of manual driving vehicles and automated driving of the automated driving vehicles that are not sufficiently advanced may adversely affect the congestion. Here, the automated driving assistance apparatus 5 according to Embodiment 1 may be installed in the manual driving vehicles that are currently widely used to collect manual driving operations in the manual driving vehicles, which will contribute to increase in the accuracy and the reliability of planned algorithms that greatly affect behaviors of the automated driving vehicles. This can contribute to reduction in traffic congestion and realization of a safe society through early introduction of the automated driving vehicles.

The automated driving assistance apparatus 5 may widely collect traveling histories, without any distinction between the subject vehicle and other vehicles and irrespective of roads or places. The automated driving assistance apparatus 5 may learn a planned algorithm for each user or for each vehicle. Such a configuration can customize, according to the preference of the user, driving behaviors of an automated driving vehicle, for example, selecting a traveling roue, selecting a traveling lane, a steering wheel operation, intensities of deceleration and acceleration, and a distance to a surrounding vehicle. In other words, the configuration can individually and highly customize a planned algorithm of the automated driving vehicle.

### Other Modifications

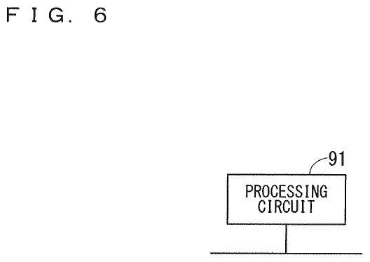

Hereinafter, the term “traveling history obtaining unit 52, etc.,” will refer to the traveling history obtaining unit 52, the traveling trajectory estimator 53, and the surrounding environment estimator 54 in FIG. 1. A processing circuit 91 in FIG. 6 embodies the traveling history obtaining unit 52, etc. In other words, the processing circuit 91 includes: the traveling history obtaining unit 52 obtaining a traveling history; the traveling trajectory estimator 53 estimating a traveling trajectory of the subject vehicle by checking the traveling history against map information; and the surrounding environment estimator 54 estimating a surrounding environment of the subject vehicle based on a manual driving operation on the traveling trajectory, the surrounding environment being used as learning data of a planned algorithm for planning control of the automated driving of the subject vehicle. The processing circuit 91 may be dedicated hardware, or a processor that executes a program stored in a memory. The processor is, for example, a central processing unit, a processing unit, an arithmetic unit, a microprocessor, a microcomputer, or a digital signal processor (DSP).

When the processing circuit 91 is dedicated hardware, it is, for example, a single circuit, a composite circuit, a programmed processor, a parallel-programmed processor, an application-specific integrated circuit (ASIC), a field-programmable gate array (FPGA), or any combinations thereof. The functions of each of the units, for example, the traveling history obtaining unit 52, etc., may be implemented by a circuit obtained by distributing processing circuits, or the functions of the units may be collectively implemented by a single processing circuit.

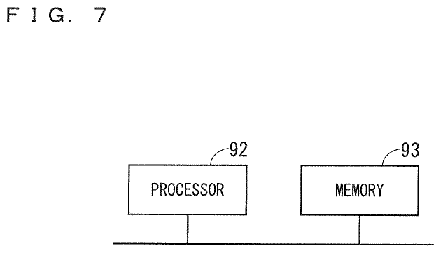

When the processing circuit 91 is a processor, the processing circuit 91 combined with software, etc., implements the functions of the traveling history obtaining unit 52, etc. The software, etc., is, for example, software, firmware, or the software and the firmware. For example, the software is described as a program, and stored in a memory. As illustrated in FIG. 7, a processor 92 applied as the processing circuit 91 implements the functions of each of the units by reading and executing a program stored in a memory 93. Specifically, the automated driving assistance apparatus 5 includes the memory 93 for storing a program which, when executed by the processing circuit 91, consequently executes the steps of: obtaining a traveling history; estimating a traveling trajectory of the subject vehicle by checking the traveling history against map information; and estimating a surrounding environment of the subject vehicle based on a manual driving operation on the traveling trajectory, the surrounding environment being used as learning data of a planned algorithm for planning control of the automated driving of the subject vehicle. Put it differently, this program causes a computer to execute the procedures or the methods for the traveling history obtaining unit 52, etc. Here, the memory 93 may be, for example, a non-volatile or volatile semiconductor memory such as a random-access memory (RAM), a read-only memory (ROM), a flash memory, an electrically programmable read-only memory (EPROM), or an electrically erasable programmable read-only memory (EEPROM), a hard disk drive (HDD), a magnetic disk, a flexible disk, an optical disk, a compact disc, a minidisc, a digital versatile disk (DVD) or a drive device thereof, or further any storage medium to be used in the future.

The configuration for implementing each of the functions of the traveling history obtaining unit 52, etc., using one of the hardware and the software, etc., is described above. However, the configuration is not limited to this, but a part of the traveling history obtaining unit 52, etc., may be implemented by dedicated hardware, and another part thereof may be implemented by software, etc. For example, the processing circuit 91, an interface, and a receiver which function as dedicated hardware can implement the functions of the traveling history obtaining unit 52, whereas the processing circuit 91 functioning as the processor 92 can implement functions of the constituent elements other than the traveling history obtaining unit 52 through reading and executing a program stored in the memory 93.

As described above, the processing circuit 91 can implement each of the functions by hardware, software, etc., or any combinations of these. The same applies to the functions of the learning unit 55.

The automated driving assistance apparatus 5 described above is applicable to an automated driving assistance system constructed as a system by appropriately combining vehicle equipment, communication terminals including mobile terminals such as a mobile phone, a smartphone, and a tablet, functions of applications to be installed into at least one of the vehicle equipment or the communication terminals, and a server. The functions and the constituent elements of the automated driving assistance apparatus 5 described above may be dispersively allocated to each of the devices constructing the system, or allocated to any one of the devices in a centralized manner. The automated driving assistance system may be, for example, a system in which the traveling history obtaining unit 52, the traveling trajectory estimator 53, and the surrounding environment estimator 54 are installed in a vehicle and the learning unit 55 is installed in a server.

Embodiments can be appropriately modified or omitted. The foregoing description is in all aspects illustrative, and is not restrictive. It is therefore understood that numerous modifications and variations that have not yet been exemplified can be devised.

### EXPLANATION OF REFERENCE SIGNS

5 automated driving assistance apparatus, 52 traveling history obtaining unit, 53 traveling trajectory estimator, 54 surrounding environment estimator.

1. An automated driving assistance apparatus assisting automated driving of a vehicle, the automated driving assistance apparatus comprising:
a traveling history obtaining circuitry to obtain a traveling history including a manual driving operation on the vehicle, a vehicle position that is a position of the vehicle, and a time of the manual driving operation and a time at the vehicle position;
a traveling trajectory estimator to estimate a traveling trajectory of the vehicle by checking the traveling history against map information; and
a surrounding environment estimator to estimate a surrounding environment of the vehicle based on the manual driving operation on the traveling trajectory, the surrounding environment being used as learning data of a planned algorithm for planning control of the automated driving of the vehicle,
wherein the surrounding environment estimator estimates the surrounding environment, using the traveling trajectory corrected through a sequential simulation in which a physical vehicle model has been applied to traveling of the vehicle, the physical vehicle model representing a dynamic behavior of the vehicle.

2. (canceled)

3. The automated driving assistance apparatus according to claim 1,
wherein the traveling trajectory estimator determines a section in which the traveling trajectory estimator performs the check, based on the traveling history.

4. An automated driving assistance apparatus assisting automated driving of a vehicle, the automated driving assistance apparatus comprising:
a traveling history obtaining circuitry to obtain a traveling history including a manual driving operation on the vehicle, a vehicle position that is a position of the vehicle, and a time of the manual driving operation and a time at the vehicle position;
a traveling trajectory estimator to estimate a traveling trajectory of the vehicle by checking the traveling history against map information; and
a surrounding environment estimator to estimate a surrounding environment of the vehicle based on the manual driving operation on the traveling trajectory, the surrounding environment being used as learning data of a planned algorithm for planning control of the automated driving of the vehicle,
wherein when the traveling trajectory estimator estimates a plurality of traveling trajectories including the traveling trajectory, the surrounding environment estimator estimates the surrounding environment, using a traveling trajectory whose manual driving operation is less among the plurality of traveling trajectories.

5. The automated driving assistance apparatus according to claim 1,
wherein the traveling trajectory and the planned algorithm are used to generate control information for controlling the automated driving in the vehicle.

6. A method for assisting automated driving of a vehicle, the method comprising:
obtaining a traveling history including a manual driving operation on the vehicle, a vehicle position that is a position of the vehicle, and a time of the manual driving operation and a time at the vehicle position;
estimating a traveling trajectory of the vehicle by checking the traveling history against map information;
estimating a surrounding environment of the vehicle based on the manual driving operation on the traveling trajectory, the surrounding environment being used as learning data of a planned algorithm for planning control of the automated driving of the vehicle; and
estimating the surrounding environment, using the traveling trajectory corrected through a sequential simulation in which a physical vehicle model has been applied to traveling of the vehicle, the physical vehicle model representing a dynamic behavior of the vehicle.
